(19) United States
(12) Patent Application Publication
(10) Pub. No.: US 2012/0293631 A1
(43) Pub. Date: Nov. 22, 2012

(54) METHODS FOR IMPLEMENTING A BEHAVIOR ANALYSIS OF A RODENT IN AN ARENA AND METHODS FOR GENERATING AN IMAGE OF THE RODENT

(76) Inventors: Stephan Schwarz, Bonn (DE); Christian Gutzen, Bonn (DE)

(21) Appl. No.: 13/475,415

(22) Filed: May 18, 2012

(30) Foreign Application Priority Data
May 18, 2011 (DE) 10 2011 101 939.5

(51) Int. Cl. H04N 13/02

(52) U.S. Cl. 348/47; 348/E13.074; 348/E13.014

(57) ABSTRACT

Example methods are disclosed for generating an image of a rodent in an arena that include generating two pictures of the rodent by two spaced apart cameras, whereas both cameras capture one or more of the rodent or the arena from above and generating a three-dimensional vertical profile of the rodent on the pictures. An example method also includes storing the vertical profile as an image of the rodent.

### RELATED APPLICATION

This patent claims the benefit of German Patent Application DE 10 2011 101 939.5, which was filed on May 18, 2011, and which is hereby incorporated by reference in its entirety.

### FIELD OF THE DISCLOSURE

The present disclosure relates to a method for implementing a behavior analysis of a rodent in an arena and a method for generating an image of the rodent.

### BACKGROUND

A method for the analysis of the behavior of a mouse in an arena is known from WO 2010/032247 A2 in which a single camera, which captures images of the mouse and of the arena at determined time intervals from a bird's eye view, is provided above the arena. These images are interpreted in a connected processing unit by identifying behavioral patterns from the images and by statistically processing these behavioral patterns.

Thereby, the single camera can merely generate two-dimensional images of the mouse and/or the arena, the consequence being that some behavioral patterns of the mouse, for instance rearing, cannot be identified.

Using two different cameras for the analysis of the behavior of several mice is known from WO 2010/051164 A1, wherein a camera captures the mice and/or the arena from a bird's eye view, while the other camera captures a lateral view. Both images are then interpreted in a connected processing unit, by comparing both images in parallel with stored images of behavioral patterns and by statistically processing identified behavioral patterns.

In the method according to WO 2010/051154 A1 the images of both cameras must be processed simultaneously, which requires very complex software as well as a lot of calculating time, which ultimately leads to a slower processing.

### BRIEF DESCRIPTION OF THE DRAWINGS

FIG. 1 shows a schematically represented configuration of a system for implementing a behavior analysis according to the teachings of the present disclosure.

FIG. 2 shows a schematic representation of a short sequence with three images of a rodent.

FIG. 3 shows a schematic representation of a short sequence with four images of a rodent.

### DETAILED DESCRIPTION

The present disclosure relates to methods for implementing a behavior analysis of a rodent in an arena and for generating an image of the rodent. One object of the present disclosure is to establish a method for implementing a behavior analysis and a method for generating an image of a rodent, so that a plurality of behavioral patterns is captured in a short time. According to the present disclosure, a method for generating an image of a rodent in an arena and a method for implementing a behavior analysis as recited in the claims are proposed as a technical solution to this object.

An example method for generating an image of a rodent (such as, for example, a mouse or a rat) in an arena (to, for example, implement a behavior analysis) includes generating two pictures of the rodent by two spaced apart cameras, whereas both cameras capture one or more of the rodent or the arena from above and generating a three-dimensional vertical profile of the rodent on the pictures. The example method also includes storing the vertical profile as an image of the rodent.

In some examples, generating the three-dimensional vertical profile includes optically capturing the arena and one or more objects in the arena without the rodent using the two spaced apart cameras, determining first surface points in space of the captured objects based on first picture data of both cameras and saving the first surface points of the objects as arena data. Also, the generation of the three-dimensional vertical profile includes optically capturing the arena and the one or more objects and the rodent using the two spaced-apart cameras, determining second surface points in space of the captured objects and of the captured rodent based on second picture data of both cameras and saving the second surface points of the objects and of the rodent as work data. In addition, the generation of the three-dimensional vertical profile includes extracting the arena data from the work data to generate remaining surface points of the first and second surface points, wherein the remaining surface points form the three-dimensional vertical profile of the rodent.

In some examples, the first and second surface points are determined by means of triangulation of the first and second picture data of both cameras. Also, in some examples, extracting the arena data from the work data comprises subtracting the first surface points of the arena data from the second surface points of the work data.

Some of the example methods disclosed herein also include calculating a center of gravity in space of the rodent based on the vertical profile and storing the vertical profile with the center of gravity as an image.

Also, some example methods include calculating the snout tip in space of the rodent based on the vertical profile and storing the vertical profile with the snout tip as an image. In some examples, calculating the snout tip in space based on the vertical profile includes determining a two-dimensional contour of the rodent based on the vertical profile and determining a section of the contour with an acute angle by means of angle analysis. Calculating the snout tip, in some examples, also includes assigning X, Y, and Z coordinates from the vertical profile to the angular point of the acute angle and saving these coordinates as the snout tip.

Some example methods include calculating the extremity of the tail in space of the rodent based on the vertical profile and storing the vertical profile with the extremity of the tail as an image. In some examples, calculating the extremity of the tail in space based on the vertical profile includes determining the tail based on the vertical profile through comparison with standard tails, defining a free end of the tail as the extremity of the tail and X, Y and Z coordinates of the extremity of the tail being taken from the vertical profile, and saving these coordinates as the extremity of the tail .

In addition, some example disclosed herein include implementing a behavior analysis of the rodent by using the image of the rodent generated at a certain moment, generating one or more other images of the rodent at one or more different moments, and assembling successive images into a video sequence for following movements of the rodent. Some examples include processing the video sequence by comparing the movements of the rodent with stored behavioral patterns, classifying the movements of the rodent into one or several behavioral patterns, and saving the classified behavioral patterns.

Some examples disclosed herein include generating an image of the rodent is generated about every 15 to about every 100 milliseconds including, for example, about every 40 milliseconds. Also, some examples include combining between about 3 and about 100 pictures into a video sequence including, for example, between about 5 and about 30 pictures. Furthermore, in some examples, the classified behavioral patterns are saved in a descriptive statistic.

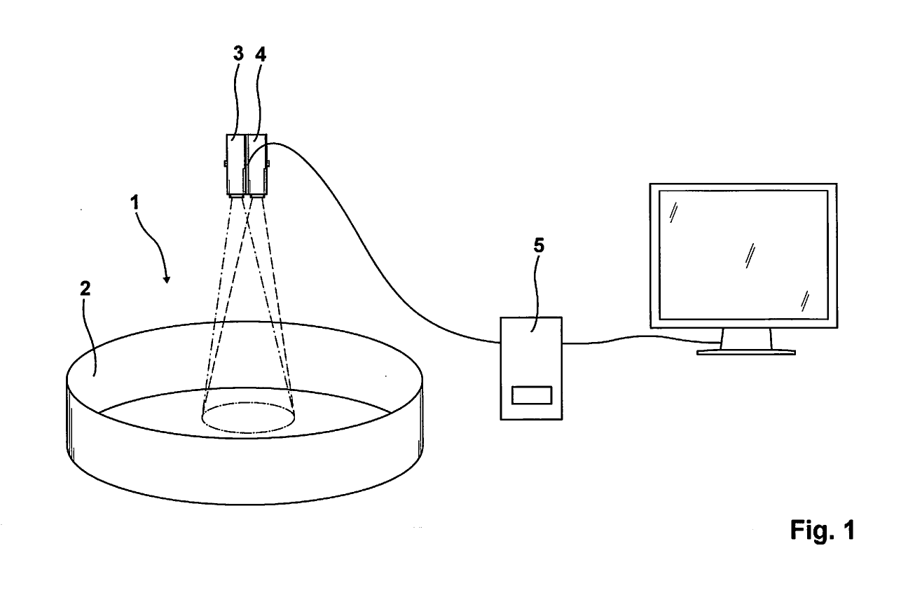

Turning now to the figures, FIG. 1 shows an arrangement for generating an image of a rodent in an arena. This arrangement comprises an arena 1 with a circular arena wall 2 for receiving a rodent, in this case a mouse, which is not shown.

Two cameras 3 and 4 are attached above the arena 1 in such a manner that each of the cameras 3, 4 can capture the entire arena 1 in one picture. The cameras 3, 4 are thereby disposed as closely to each other as possible, so that both cameras 3, 4 capture almost the same picture section. At the same time, both cameras 3, 4 are disposed at such a distance from each other that a number of three-dimensional surface points of the objects and/or the rodent can be determined from the obtained pictures by way of triangulation.

The cameras 3, 4 are connected to a processing unit with a memory 5, which calculates a vertical profile of the rodent based on the surface points. All the behavioral patterns that are relevant for the behavior analysis are stored in the memory.

The vertical profile is calculated as follows:

A.1 optical capture of the arena with all its objects without the rodent by two spaced apart cameras;

A.2 determining surface points in space of the captured objects based on the picture data of both cameras, more specifically by means of triangulation;

A.3 saving the surface points of the objects as arena data;

A.4 optical capture of the arena with all its objects and with the rodent by the two spaced apart cameras;

A.5 determining surface points in space of the captured objects and of the captured rodent based on the picture data of both cameras, more specifically by means of triangulation;

A.6 saving the surface points of the objects and of the rodent as work data;

A.7 extraction of the arena data from the work data, more specifically by subtracting the arena data from the work data, so that the remaining surface points form a three-dimensional vertical profile of the rodent and saving the remaining three-dimensional vertical profile of the rodent.

The center of gravity 8 of the rodent in space, the extremity of the tail 7 in space and the position of the snout tip 9 in space is subsequently calculated based on the vertical profile. Everything is then saved together with the vertical profile as an image.

The snout tip 9 in space is calculated based on the vertical profile by determining a two-dimensional contour of the rodent based on the vertical profile, determining a section of the contour with an acute angle by means of angle analysis, assigning the X, Y, and Z coordinates from the vertical profile to the angular point of the acute angle and saving these coordinates as the snout tip 9.

The extremity of the tail 7 in space is calculated based on the vertical profile by determining the tail through comparison with standard tails, defining the free end of the tail as the extremity of the tail 7, the X, Y and Z coordinates of the extremity of the tail 7 being taken from the vertical profile and by saving these coordinates as the extremity of the tail 7.

Furthermore, reference video sequences from a number of reference images are stored in the memory of the processing unit for each wanted behavioral pattern. For implementing a behavior analysis, 5 to 30 images in sequence, for example, are combined to form a video sequence.

Each video sequence is then compared to all the reference video sequences and if there is a sufficiently high concurrence between the video sequence and the reference video sequence, the identified behavior pattern is saved in a descriptive statistic.

In the following a behavior analysis is exemplarily described:

1. Capture of the empty arena 1 by both cameras 3, 4 and generating an image of the objects of the arena 1 by means of triangulation;

2. Capture of the arena 1 occupied by a rodent by both cameras 3, 4 and generating an image of the objects of the arena 1 by means of triangulation;

3. Subtraction of the image of the empty arena 1 from the image of the arena 1 occupied by a rodent, in order to isolate the rodent from all the objects in the arena;

4. The isolated object is examined to verify that it is a mouse. Thereby the size of the object and the presence of certain features such as a tail for instance are checked;

5. The position of the tail and head as well as the contour of the mouse is subsequently determined;

6. For capturing the orientation of the mouse, the position of the head relative to the tail is determined, in order to find out for instance whether the mouse is rearing or is on the floor;

7. Identifying the behaviors through analysis of the chronological sequence of the orientation of the mouse, for instance in order to find out if the mouse is cleaning itself, since in this case the erect position of the mouse is accompanied by a characteristic modification of the angles of the body.

8. Repeating steps 2 to 7.

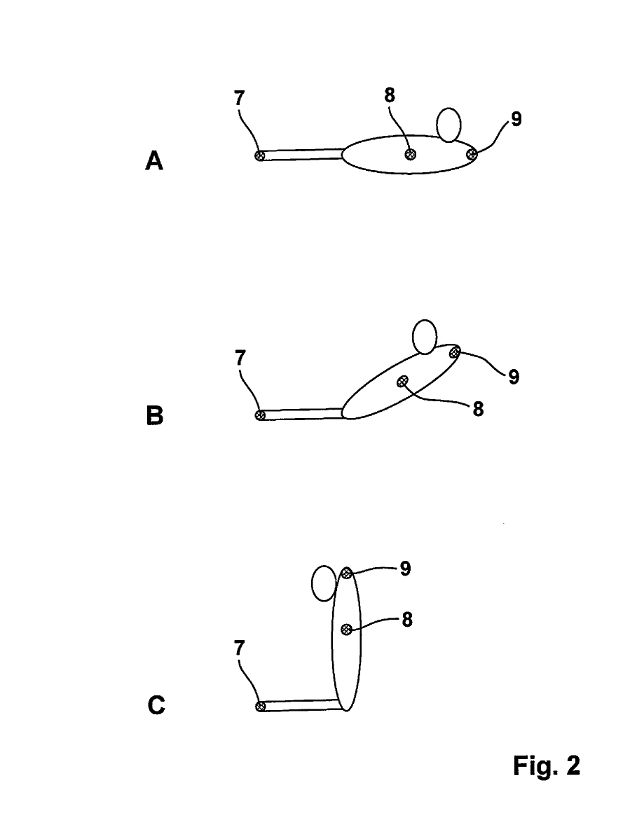

A short sequence with 3 images of a rodent in which the extremity of the tail 7, the center of gravity 8 and the snout tip 9 have already been determined, is schematically shown in FIG. 2

If based on these three images it is determined that the snout tip 9 is higher than the center of gravity 8 and that the center of gravity 8 is higher than the extremity of the tail 7, this behavior is classified as “rearing” and correspondingly noted in the descriptive statistic.

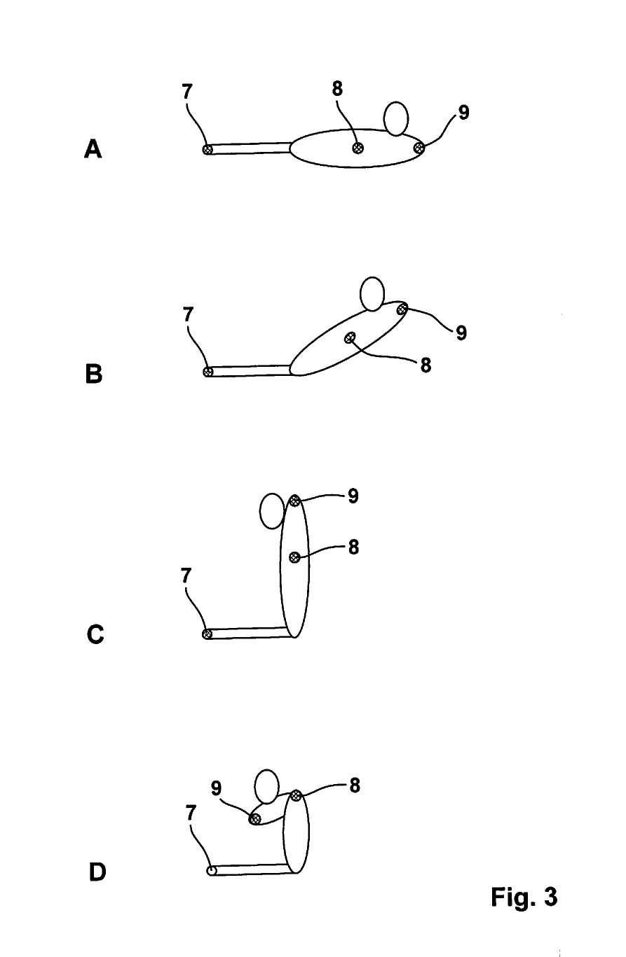

FIG. 3 schematically shows a short sequence with 4 images of a rodent, in which the extremity of the tail 7, the center of gravity 8 and the snout tip 9 have already been determined

If based on these 4 images it is determined that the snout tip 9 is higher than the center of gravity 8 and the center of gravity 8 is higher than the extremity of the tail 7 and that the snout tip 9 subsequently lies at the same level or even below the center of gravity, this behavior will be classified as “cleaning” and correspondingly noted in the descriptive statistic.

A video sequence can also be composed of up to 100 images, for example, and comprise one of more behavioral patterns. Thereby, it has proven advantageous to generate an image every 15 to 100, such as, for example, every 40 milliseconds.

The example methods and systems disclosed herein have the advantage that by using two cameras, a three-dimensional vertical profile can be generated, with which individual behavioral patterns can be identified. Individual body parts such as the body, the tail or the tip of the snout can then be deduced from the vertical profile and using relative correlation of the individual body parts, for instance using the distance of the individual body parts relative to the floor or of the body parts to each other, all biologically relevant behavior patterns can be identified, more specifically rearing or snout cleaning.

In some examples disclosed herein surface points of the objects and/or the rodent are captured by means of both cameras, wherein the position in space of each surface point can be assigned to it, for instance by means of its X, Y and Z coordinated. This is advantageous in that the three-dimensional position of individual body parts of the rodent is recognized, which strongly simplifies the determination of the respective behavioral pattern.

The center of gravity of the rodent, the tip of the snout and the extremity of the tail in space are then respectively calculated based on the vertical profile. Thus an accurate, three-dimensional position of these points in space is provided. These points essentially determine the image of the mouse.

The example methods and system for implementing a behavior analysis by using the images disclosed herein is advantageous in that the images generated from the three-dimensional vertical profile allow for the identification of all relevant behavioral patterns, so that the behavior analysis can be carried out quickly and with little computing time.

Another advantage is that more data is available for processing in the available time, so that the result of the analysis is more precise.

Other advantages of the methods and systems according to the present examples are shown in the attached drawing and the embodiments disclosed herein. Any features disclosed herein may be used individually or in any combination of one another. The mentioned embodiments must not be understood as an exhaustive enumeration but rather as mere examples.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method for generating an image of a rodent in an arena comprising:
generating two pictures of the rodent by two spaced apart cameras, whereas both cameras capture one or more of the rodent or the arena from above;
generating a three-dimensional vertical profile of the rodent on the pictures; and
storing the vertical profile as an image of the rodent.

2. The method according to claim 1, wherein generating the three-dimensional vertical profile comprises:
optically capturing the arena and one or more objects in the arena without the rodent using the two spaced apart cameras;
determining first surface points in space of the captured objects based on first picture data of both cameras;
saving the first surface points of the objects as arena data;
optically capturing the arena and the one or more objects and the rodent using the two spaced-apart cameras;
determining second surface points in space of the captured objects and of the captured rodent based on second picture data of both cameras;
saving the second surface points of the objects and of the rodent as work data; and
extracting the arena data from the work data to generate remaining surface points of the first and second surface points, wherein the remaining surface points form the three-dimensional vertical profile of the rodent.

3. The method according to claim 2, wherein the first and second surface points are determined by means of triangulation of the first and second picture data of both cameras.

4. The method according to claim 2, wherein extracting the arena data from the work data comprises subtracting the first surface points of the arena data from the second surface points of the work data.

5. The method according to claim 1 further comprising:
calculating a center of gravity in space of the rodent based on the vertical profile; and
storing the vertical profile with the center of gravity as an image.

6. The method according to claim 1 further comprising:
calculating the snout tip in space of the rodent based on the vertical profile; and
storing the vertical profile with the snout tip as an image.

7. The method according to claim 6, wherein calculating the snout tip in space based on the vertical profile comprises:
determining a two-dimensional contour of the rodent based on the vertical profile;
determining a section of the contour with an acute angle by means of angle analysis;
assigning X, Y, and Z coordinates from the vertical profile to the angular point of the acute angle; and
saving these coordinates as the snout tip.

8. The method according to claim 1 further comprising:
calculating the extremity of the tail in space of the rodent based on the vertical profile; and
storing the vertical profile with the extremity of the tail as an image.

9. The method according to claim 8, wherein calculating the extremity of the tail in space based on the vertical profile comprises:
determining the tail based on the vertical profile through comparison with standard tails;
defining a free end of the tail as the extremity of the tail;
defining X, Y and Z coordinates of the extremity of the tail being taken from the vertical profile; and
saving these coordinates as the extremity of the tail.

10. The method according to claim 1 further comprising implementing a behavior analysis of the rodent by:
using the image of the rodent generated at a certain moment;
generating one or more other images of the rodent at one or more different moments;
assembling successive images into a video sequence for following movements of the rodent;
processing the video sequence by comparing the movements of the rodent with stored behavioral patterns;
classifying the movements of the rodent into one or several behavioral patterns; and
saving the classified behavioral patterns.

11. The method of claim 10, wherein generating one or more other images comprises generating an image of the rodent is generated about every 15 to about every 100 milliseconds.

12. The method of claim 10, wherein assembling successive images comprises combining between about 3 and about 100 pictures into a video sequence.

13. The method of claim 10, wherein saving the classified behavioral patterns comprises saving the classified behavioral patterns in a descriptive statistic.
